(19) United States
(12) Patent Application Publication
(10) Pub. No.: US 2017/0348839 A1
(43) Pub. Date: Dec. 7, 2017

(54) Connector Release Tool

(71) Applicant: Ricky Lynn Pierce, MABANK, TX (US)

(72) Inventor: Ricky Lynn Pierce, MABANK, TX (US)

(21) Appl. No.: 15/173,341

(22) Filed: Jun. 3, 2016

(51) Int. Cl. B25B 27/14; B25B 7/22

(52) U.S. Cl. CPC B25B 27/14; B25B 7/22

(57) ABSTRACT

A release tool for cable connector, Having opposed levers with a spreader tip and a locator tip arranged thereon, and adapted to provide an instant force to a cable connector, such that a degree of retainment is reached which effects and adjustment of the fit value of the connector with respect to a grip object to a release value, at which point a grip object within the connector is released.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to tools and more specifically to automotive tools and hand tools and automobile repairs.

### BACKGROUND

It is a persistent problem that replacement and maintenance procedures of parking brake cables include many difficult tasks, particularly with respect to procedures that require handling a single-installation, semi-disposable part, such as a tensile-retainment parking cable connector. One problem that gave rise to conception of the present invention, which has applications beyond the token problem, is how to remove a parking cable connector which is connected, in tension, between a parking brake pedal to a parking brake clamping mechanism in the rear wheels of a pick up truck or other passenger vehicle.

Many embodiments of such connectors are simple rolled and crimped sections of sheet metal. However, while such connectors are painlessly consumed during replacement, as their simple construction allows for low material cost, their simple construction negates that cost savings by creating the pertinent problem: consequential labor costs of the time spent performing a replacement.

Even in the case of where the connector is very cheap, the time and number of tasks necessary in order to remove it and replace it are disproportionately numerous and of significant duration. Releasing such a part, in any of several alternative automotive repairs to a parking brake system, requires loosening the fit of the connector with respect to an end connector of at least one cable. Typically, this requires relieving tension on the parking brake cable components, so that the two sub-cables are able to be slid towards one another and removed through the side of the connector, at least in one common embodiment of connector. Typical ways to deal with this are simply to destroy the connector, by either prying walking components away from one another with the screwdriver, which can be very challenging, or to take a power tool or other cutting equipment to the connector, and destroy it. Even ways that avoid having to disassemble brake assemblies, in order to reach a component that allows for loosening the tension on the system, are still excessively time-consuming.

There is a need in the art to devise a cheap and expedient way to release the two cables from one another, and perhaps a target for innovation/conception of a solution is in manipulation of such a cable connector.

### SUMMARY

The exemplary embodiments given in this section do not define all contemplated embodiments, nor embodiments that should be reasonably considered within the claimed invention. The invention is not limited to the disclosed embodiments.

One embodiment of the present invention is a tool having a spreader tip, that spreader tip being adapted to engage a cable connector, such that use of the tool allows for the connector to release tip-features of objects which are retained in physical relative location as a result of the retainment of the grip to the connector.

One very specific embodiment which in no way limits the present invention against embodiments varying any of the following limitations of such a specific embodiment, of the previous paragraph is a manual hand-tool with a long gate handles similar in form to an opposed-lever wrench.

In such an embodiment, on each of the opposed levers is a connector spreader tip and respectively, a locating tip, The embodiment is shaped and sized such that its tips are appropriately size, shape, and located to centeringly fit a cable-connector therebetween. The spreader tip is a rounded shape, or any other shape sufficiently progressively increasing in width, such that it can be pressed against a connector to apply a particular amount of force. That amount of force can be applied at an instant magnitude during compression to spread and hold a connector to a desired degree of retainment. Where the connector is in a state of retainment of a grip object, such as a collet cable-end of a parking brake cable, sufficiently holding the embodiment with such a force, such that the connector is spread to a desired degree that is broader than in an uncompressed state, has the effect of loosening the connectors retainment of the grip object. Reducing the retainment loosens the fit of the connector to a lower fit value. Thereby, the grip object may be freed or otherwise slipped out of portion of the connector which retains it.

To assist application of the embodiment to the connector, the locating tip has a shape which complements that of the spreader tip. An appropriate shape is a groove or other concave shape having similar degree of curvature to the positive curvature of the spreader tip. One advantage of such an embodiment is that a rounded connector would be retained against slipping along the locating tip, when compressed by the spreader tip, where the spreader tip is centered or otherwise aligned with respect to such a groove on the locating tip.

In one contemplated embodiment, the present invention is sized to engage the series-connecting parking cable connector for a General Motors pick up truck's mid-bed parking cable connector, retaining the rearmost collet of an intermediate cable of the cable system, and the frontmost collet of the rear cable which connects to the rear brake assembly. That connector is typically a stamped-sheet metal plate which is rolled into a cuff that is not completely closed in circumference. Along the length of the connector, there is a distinct pair of end sections and a central section. The ends sections of the cuff have a circumference which is sufficiently enclosing to retain one of the cable-collets. The central section is less-complete in circumference than the end sections, such that one of the collets may be slid into the connector through the gap in the circumference, and then slid axially, to be retained within an end section.

To use such an embodiment to grip the above exemplary contemplated connector, the spreader tip would have a diameter of approximately 10-11 mm, the groove in the locating tip would have a diameter of 1-3 mm., and both of the spreader tip and locating tip and groove/concavity would be located radially a similar distance from a pivot point. An appropriate exemplary value of this distance being 1.5-2 inches, where in exemplary link for the device is approximately 8 inches.

In no way does the exemplary embodiment given above limit the claimed invention to an embodiment assembled only this way, as other contemplated exemplary embodiments include, for example, ones which apply a linkage or a translating spreader tip, or any other mechanism which allows a force to be applied through the spreader tip.

### BRIEF DESCRIPTION OF THE DRAWINGS

The embodiments are illustrated by way of example and not limitation in the figures of the accompanying drawings in which like references indicate similar elements.

FIG. 1 shows a side elevation of an embodiment of a connector releasing device.

FIG. 2 shows a perspective view of an embodiment of a connector releasing device engaging with an embodiment of a connector of the prior art.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

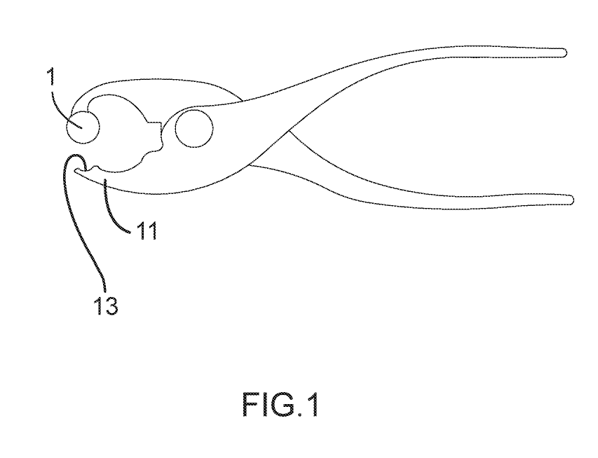

Referring now to FIG. 1, what is shown is a side elevation view of an embodiment of a connector (3) releasing device. It comprises a connector (3)-spreader tip (1), the spreader tip being substantially round in shape. It also comprises a locating tip (11). The locating tip (11) having a groove (13), the groove having a complementary shave to the spreader tip (1). The spreader tip and locating tip (11) are located on opposed levers.

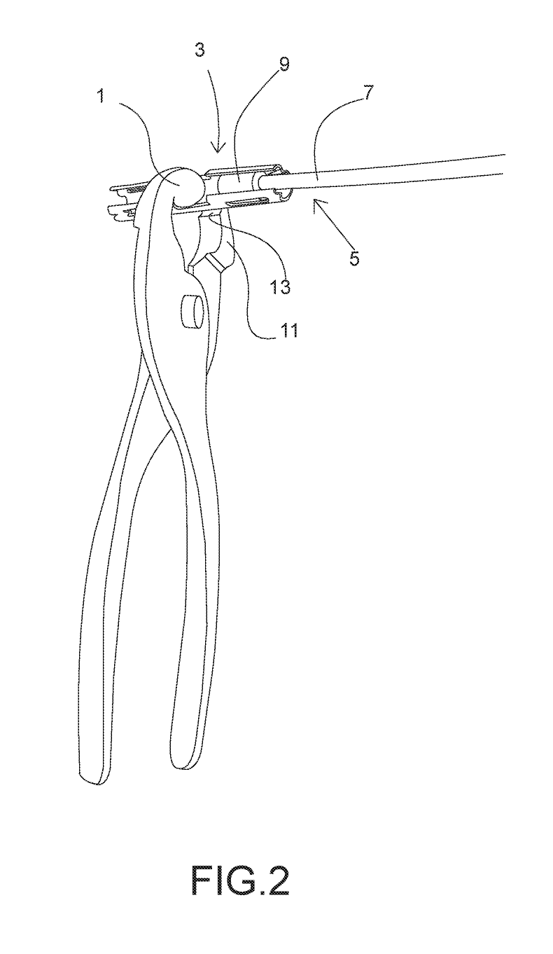

Referring now to FIG. 2, what is shown is a perspective view of an embodiment of a connector releasing device engaging with an embodiment of a connector (3) of the prior art. It comprises a connector-spreader tip (1), The spreader tip (1) being substantially round in shape. It also comprises a locating tip (11), the locating tip having a groove (13), the groove having a complementary shape to the spreader tip (1). The spreader tip (1) and locating tip (11) are located on opposed levers.

A connector (3) of the prior art is located between the spreader tip (1) and the locating tip (11). Retained within one of the ends of the connector (3) is a grip object (5). The grip object (5) comprises a cable (7) and a collet (9). The fit value retaining the grip object (5) to the connector (3) with respect to the connector (3) is controlled by the degree of retainment of the connector (3). When a force is applied to provide an instant force to the opposed levers, the spreader tip (1) and locating tip (11) apply a sufficient force to the spreader tip (1) so as to effect a desired degree of retainment, adjusting the fit value of the connector (3) to an amount which is sufficient to allow the grip object (5) to be released from retainment within the end of the connector (3). Such a value could be considered a release value, release value being a value of fit beyond which grip with respect to a grip object (5) is no longer within a range of retainment fit values.

The illustrated embodiments in the drawings do not limit the claimed invention to any particular number or type of connector or grip objects retained with respect to any type of connector.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A device, comprising a connector-spreader tip, the spreader tip being adapted to engage a grip-connector, wherein
the spreader is adapted to engage the connector by being adapted to apply to the connector an instant force to effect a desired degree of retainment of the connector with respect to a grip object.

2. The device of claim 1, further wherein said force is adapted to reduce the degree of retainment of the connector, with respect to the grip object.

3. The device of claim 1 wherein said spreader tip comprises a progressively broadening shape that is substantially round.

4. The device of claim 3, wherein the shape is Round by being a shape that is round in at least two planes, one selected from a list comprising a sphere, a cylinder, a teardrop, and an ovoid.

5. The device of claim 1, wherein the grip connector comprises a length, and is progressively shaped in transverse section along the length, comprising an lengthwise interval of section wherein the curvature has incomplete circumference.

6. The device of claim 5, the section being pliant within a range of values of curvature, comprising a Fit value range defined by a release value.

7. The device of claim 6, wherein the device is adapted to manipulate the curvature to at least the release value.

8. The device of claim 1, wherein the grip object comprises a cable.

9. The device of claim 1, wherein the grip object comprises an end feature adapted to being gripped, selected from a list comprising a collet, a nub, a handle, a hub, a pin, a bar, a key, a snapring, and a knot.

10. The device of claim 1, wherein the connector is adapted to effect a desired degree of retainment from the instant force, with respect to a second grip object.

11. The device of claim 1, wherein the device is adapted to engage a grip connector by comprising a locating tip, the locating tip having a complementary shape and arrangement with respect to the spreader tip.

12. The device of claim 11, the locating tip having a complementary shape by having a relative concavity, such shape being one selected from a list comprising a groove, a recess, a decent, a valley, and a channel.

13. The device of claim 11, the locating tip having a complementary shape by a having a shape adapted to centeringly locate the connector into alignment between the spreader tip and the locating tip.

14. The device of claim 13, wherein the device is adapted to maintain the alignment of an connector selected from a variety of alternative connectors having a variety of section sizes by being articulable by having a construction allowing regular alignment over a significant range of motion sufficient to engage any of the variety of section sizes.
